(19) United States
(12) Patent Application Publication
(10) Pub. No.: US 2012/0267975 A1
(43) Pub. Date: Oct. 25, 2012

(54) EMBEDDED PERMANENT MAGNET ELECTRIC MOTOR

(75) Inventors: Shinji NISHIMURA, Chiyoda-ku (JP); Yoichi Kuroda, Chiyoda-ku (JP); Masaya Inoue, Chiyoda-ku (JP); Moriyuki Hazeyama, Chiyoda-ku (JP)

(73) Assignee: MITSUBISHI ELECTRIC CORPORATION, Tokyo (JP)

(21) Appl. No.: 13/246,107

(22) Filed: Sep. 27, 2011

(30) Foreign Application Priority Data
Apr. 21, 2011 (JP) 2011-094744

(51) Int. Cl. H02K 1/27

(52) U.S. Cl. 310/156.01

(57) ABSTRACT

The embedded permanent magnet electric motor includes: a rotor having: a rotor core that has an outer circumferential surface that is constituted by a plurality of convex surfaces that are circular arc-shaped curved surfaces that are arranged continuously at a uniform angular pitch circumferentially; and a plurality of permanent magnets that are embedded in the rotor core so as to be positioned on a radially inner side of each of the circular arc-shaped curved surfaces; and a stator having: a stator core in which teeth are respectively disposed so as to extend radially inward from an annular core back and are arranged at a uniform angular pitch circumferentially to configure open slots; and a stator coil that is constituted by a plurality of concentrated winding coils that are wound into concentrated windings on each of the teeth.

### BACKGROUND OF THE INVENTION

1. Field of the Invention

The present invention relates to an embedded permanent magnet electric motor that is used in an automotive motor, for example.

2. Description of the Related Art

Conventional permanent magnet synchronous electric motors include: a stator that has: a stator core that is configured by arranging a plurality of core segments annularly; and a stator coil that is constituted by a concentrated winding coil that is wound into concentrated windings on respective teeth of the core segments; and a rotor that is configured by fixing a plurality of permanent magnets to an outer circumferential surface of a cylindrical rotor core (see Patent Literature 1, for example).

Patent Literature 1: Japanese Patent Laid-Open No. HEI 11-89197 (Gazette)

In conventional permanent magnet synchronous electric motors, because slots of the stator core are configured into semi-closed slots that have flange portions that extend circumferentially outward from tip ends of the teeth, it is hard to wind the stator coil, and coil inductance is greater, and one problem has been that high output cannot be achieved during high-speed rotation.

In consideration of such conditions, the stator coil is more easily wound and coil inductance can be reduced if the slots of the stator core are configured into open slots that do not have flange portions on the tip ends of the teeth. However, the change in stator magnetic flux that passes through the permanent magnets per unit time is greater, and eddy currents in the permanent magnet increase, giving rise to new problems such as the temperature of the permanent magnets increasing, the magnetic flux of the permanent magnets decreasing, or thermal demagnetization occurring.

In the semi-closed slots, the flange portions of the tooth tip ends give rise to magnetic saturation, and the change in magnetic flux density is gradual. In the open slots, however, because the flange portions of the tooth tip ends are omitted, the magnetic flux density changes suddenly at edge portions (circumferential end portions) of the teeth, and it can be inferred that large eddy currents arise in the permanent magnets.

The present applicants have conducted successive diligent investigations, and have found that eddy currents that arise in the permanent magnets can be reduced in a combination of a rotor core that has an external shape in which circular arc-shaped curved surfaces are arranged at a uniform angular pitch circumferentially (hereinafter called “a circular arc-shaped rotor core”) and open slots compared to a combination of the circular arc-shaped rotor core and semi-closed slots. Specifically, the present applicants have succeeded in inventing the present invention by finding a phenomenon that is the reverse of the above conventional wisdom that eddy currents that arise in the permanent magnets that are embedded in the rotor core can be reduced by changing the slots of the stator core from open slots to semi-closed slots if a rotor core that has an external shape that is a cylindrical surface (hereinafter “a cylindrical rotor core”) is used.

### SUMMARY OF THE INVENTION

The present invention aims to solve the above problems and an object of the present invention is to provide an embedded permanent magnet electric motor that facilitates mounting of a stator coil, that enables stator coil inductance to be reduced, and that also enables eddy currents that arise in permanent magnets to be reduced.

In order to achieve the above object, according to one aspect of the present invention, there is provided an embedded permanent magnet electric motor including: a rotor including: a rotor core that has an outer circumferential surface that is formed into a plurality of continuous convex surfaces by arranging circular arc-shaped curved surfaces at a uniform angular pitch circumferentially; and a plurality of permanent magnets that are embedded in the rotor core so as to be positioned on a radially inner side of each of the circular arc-shaped curved surfaces, the permanent magnets that are embedded in inner radial sides of adjacent circular arc-shaped curved surfaces being magnetized so as to have polarities that are different than each other to constitute magnetic poles; and a stator including: a stator core in which teeth are respectively disposed so as to extend radially inward from an annular core back and are arranged at a uniform angular pitch circumferentially to configure open slots; and a stator coil that is constituted by a plurality of concentrated winding coils that are wound into concentrated windings on each of the teeth, the stator being disposed so as to surround the rotor.

According to the present invention, because the stator core is configured so as to have open slots, mounting of the stator coil is facilitated, and stator coil inductance is also reduced, enabling high output to be achieved during high-speed rotation. Because a stator core that is configured so as to have open slots, and a rotor core that has an outer circumferential surface that is constituted by a plurality of convex surfaces in which circular arc-shaped curved surfaces are arranged continuously at a uniform angular pitch circumferentially are used, eddy currents that arise in the permanent magnets can be reduced. Thus, because eddy current loss in the permanent magnets is reduced, and temperature increases in the permanent magnets are suppressed, decreases in magnetic flux and thermal demagnetization of the permanent magnets can be prevented.

### BRIEF DESCRIPTION OF THE DRAWINGS

FIG. 1 is a cross section that schematically shows an overall configuration of an embedded permanent magnet electric motor according to Embodiment 1 of the present invention;

FIG. 2 is a graph that shows results when eddy current loss of permanent magnets in the embedded permanent magnet electric motor according to Embodiment 1 of the present invention was analyzed;

FIG. 3 is a cross section that schematically shows an overall configuration of an embedded permanent magnet electric motor according to Comparative Example 1;

FIG. 4 is a cross section that schematically shows an overall configuration of an embedded permanent magnet electric motor according to Comparative Example 2;

FIG. 5 is a cross section that schematically shows an overall configuration of an embedded permanent magnet electric motor according to Comparative Example 3;

FIG. 6 is a diagram that explains an eddy current loss reducing mechanism in an embedded permanent magnet electric motor;

FIG. 7 is a diagram that explains an eddy current loss reducing mechanism in an embedded permanent magnet electric motor;

FIG. 8 is an end elevation that schematically shows a stator core that is used in an embedded permanent magnet electric motor according to Embodiment 2 of the present invention;

FIG. 9 is an end elevation that schematically shows a stator core that is used in an embedded permanent magnet electric motor according to Embodiment 3 of the present invention;

FIG. 10 is an end elevation that schematically shows a core segment group that constitutes a stator core that is used in an embedded permanent magnet electric motor according to Embodiment 4 of the present invention;

FIG. 11 is an end elevation that schematically shows the stator core that is used in the embedded permanent magnet electric motor according to Embodiment 4 of the present invention;

FIG. 12 is an end elevation that shows a permanent magnet that is used in an embedded permanent magnet electric motor according to Embodiment 5 of the present invention;

FIG. 13 is an end elevation that shows a permanent magnet that is used in an embedded permanent magnet electric motor according to Embodiment 6 of the present invention; and

FIG. 14 is a perspective that shows a permanent magnet that is used in an embedded permanent magnet electric motor according to Embodiment 7 of the present invention.

### DETAILED DESCRIPTION OF THE PREFERRED EMBODIMENTS

Preferred embodiments of the embedded permanent magnet electric motor according to the present invention will now be explained using drawings.

### Embodiment 1

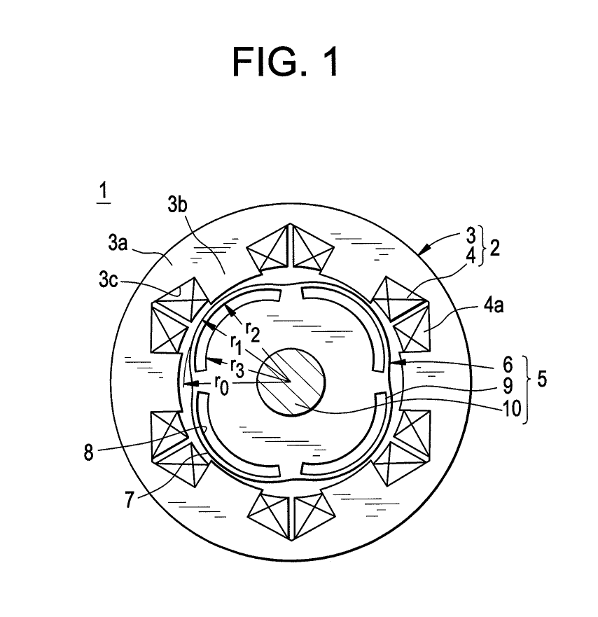

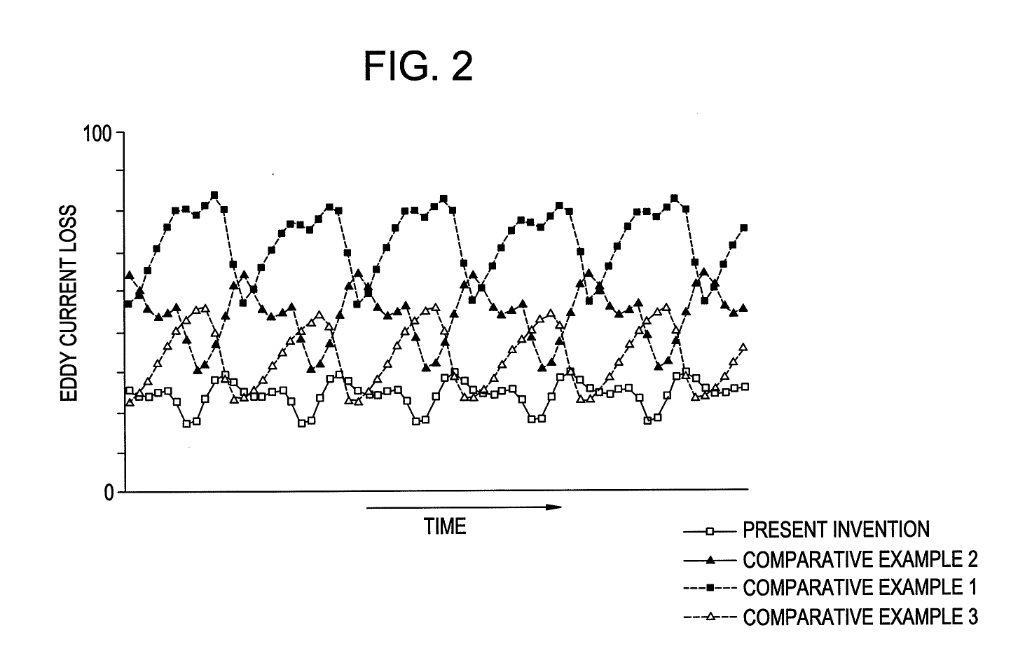

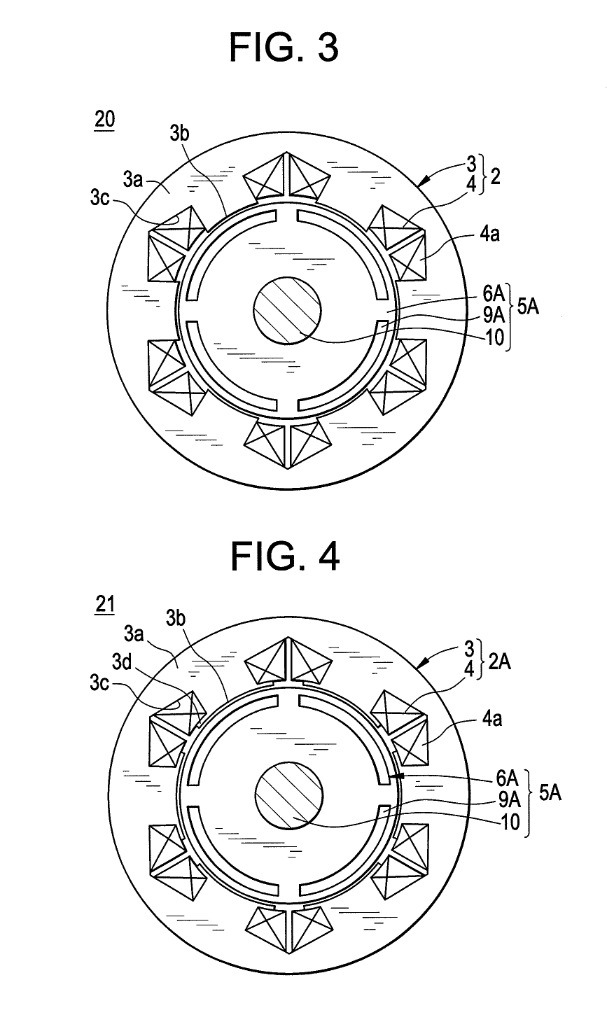

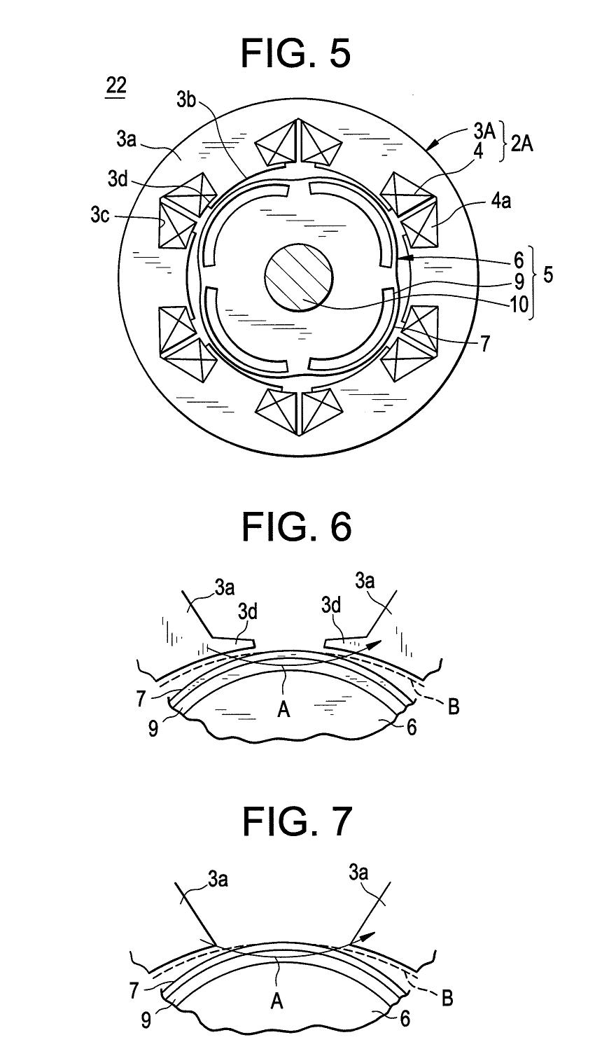

FIG. 1 is a cross section that schematically shows an overall configuration of an embedded permanent magnet electric motor according to Embodiment 1 of the present invention, FIG. 2 is a graph that shows results when eddy current loss of permanent magnets in the embedded permanent magnet electric motor according to Embodiment 1 of the present invention was analyzed, FIG. 3 is a cross section that schematically shows an overall configuration of an embedded permanent magnet electric motor according to Comparative Example 1, FIG. 4 is a cross section that schematically shows an overall configuration of an embedded permanent magnet electric motor according to Comparative Example 2, FIG. 5 is a cross section that schematically shows an overall configuration of an embedded permanent magnet electric motor according to Comparative Example 3, FIG. 6 is a diagram that explains an eddy current loss reducing mechanism in an embedded permanent magnet electric motor, and FIG. 7 is a diagram that explains an eddy current loss reducing mechanism in an embedded permanent magnet electric motor.

In FIG. 1, an embedded permanent magnet electric motor 1 includes: a stator 2 that is held by a housing (not shown); and a rotor 5 that is disposed so as to be rotatably held by the housing on an inner circumferential side of the stator 2 so as to have a predetermined air gap interposed.

The stator 2 is formed by laminating and integrating a large number of electromagnetic steel plates that have been punched into identical shapes, for example, and includes: a stator core 3 that has: an annular core back 3a; and six teeth 3b that each have a constant circumferential width, that are disposed so as to extend radially inward from an inner circumferential surface of the core back 3a, and that are arranged at a uniform angular pitch circumferentially; and a stator coil 4 that is constituted by six concentrated winding coils 4a that are wound into a concentrated winding on each of the teeth 3b of the stator core 3. Here, slots 3c that are bounded by the core back 3a and two adjacent teeth 3b are constituted by open slots that do not have flange portions on tip ends of the teeth 3b.

The rotor 5 is formed by laminating and integrating a large number of electromagnetic steel plates that have been punched into identical shapes, for example, and includes: a rotor core 6 that has an external shape in which a plurality of circular arc-shaped curved surfaces 7 are arranged at a uniform angular pitch circumferentially; permanent magnets 9 that are embedded into an inner circumferential side of each of the circular arc-shaped curved surfaces 7 of the rotor core 6; and a shaft 10 that is fixed to the rotor core 6 so as to be inserted through at a central axial position of the rotor core 6.

The rotor core 6 is a circular arc-shaped rotor core that has an external shape in which the circular arc-shaped curved surfaces 7 are arranged at a pitch of 45 degrees (a pitch of one magnetic pole) circumferentially, and in which four convex surfaces (the circular arc-shaped curved surfaces 7) are disposed continuously circumferentially. In a cross section that is perpendicular to a central axis O₀ of the shaft 10, the circular arc-shaped curved surfaces 7 are formed so as to have a circular arc of radius r₁ around O₁, and are inscribed in a circle of radius r₀ around the central axis O₀ at circumferentially central positions. In the cross section that is perpendicular to the central axis O₀ of the shaft 10, magnet insertion apertures 8 that have circular arc-shaped cross sections that are surrounded by a circular arc of radius r₂ and a circular arc of radius r₃ around O₁ are formed on inner circumferential sides of the respective circular arc-shaped curved surfaces 7 of the rotor core 6 so as to pass through axially. Moreover, line segments that pass through the circumferentially central positions of the circular arc-shaped curved surfaces 7 and the central axis O₀ are called “magnetic pole centers”.

The permanent magnets 9 are formed into rectangular shapes that have circular arc-shaped cross sections that are identical to internal shapes of the magnet insertion apertures 8, and are inserted into and fixed to the magnet insertion apertures 8. The permanent magnets 9 are mounted into the rotor core 6 such that North-seeking (N) poles and South-seeking (S) poles line up alternately circumferentially. The permanent magnets 9 that constitute the magnetic poles of the N poles are magnetized such that the direction of magnetization is oriented parallel to the magnetic pole centers and radially outward. Similarly, the permanent magnets 9 that constitute the magnetic poles of the S poles are magnetized such that the direction of magnetization is oriented parallel to the magnetic pole centers and radially inward. Moreover, sintered rare-earth magnets, for example, are used as the permanent magnets.

The embedded permanent magnet electric motor 1 that is configured in this manner operates as a four-pole, six-slot synchronous motor.

Now, results when eddy current loss of the permanent magnets in the present embedded permanent magnet electric motor 1 was analyzed are shown in FIG. 2. Moreover, in order to explain the effects of the present invention, embedded permanent magnet electric motors according to Comparative Examples 1 through 3 were prepared, and results when the eddy current loss of the permanent magnets was analyzed when the magnetomotive forces of the stator coils were equal are shown in FIG. 2.

First, configuration of the embedded permanent magnet electric motors according to Comparative Examples 1 through 3 will be explained with reference to FIGS. 3 through 5.

As shown in FIG. 3, an embedded permanent magnet electric motor 20 according to Comparative Example 1 is constituted by: a stator 2 that has: a stator core 3 in which slots 3c are configured into open slots by omitting flange portions 3d from tip ends of teeth 3b; and concentrated winding coils 4a that are wound into a concentrated winding on each of the teeth 3b; and a rotor 5A in which permanent magnets 9A are embedded into a rotor core 6A. Here, the rotor core 6A is a cylindrical rotor core that has a cylindrical surface as an outer circumferential surface. Four permanent magnets 9A are formed into rectangular shapes that have circular arc-shaped cross sections, and are embedded into an outer circumferential side inside the rotor core 6A at a uniform angular pitch circumferentially. In other words, the embedded permanent magnet electric motor 20 according to Comparative Example 1 is a combination of a cylindrical rotor core and open slots.

As shown in FIG. 4, an embedded permanent magnet electric motor 21 according to Comparative Example 2 is constituted by: a stator 2A that has: a stator core 3A in which slots 3c are configured into semi-closed slots by extending flange portions 3d circumferentially outward from tip ends of teeth 3b; and concentrated winding coils 4a that are wound into a concentrated winding on each of the teeth 3b; and a rotor 5A in which permanent magnets 9A are embedded into a rotor core 6A. In other words, the embedded permanent magnet electric motor 21 according to Comparative Example 2 is a combination of a cylindrical rotor core and semi-closed slots.

As shown in FIG. 5, an embedded permanent magnet electric motor 22 according to Comparative Example 3 is constituted by: a stator 2A that has: a stator core 3A in which slots 3c are configured into semi-closed slots by extending flange portions 3d circumferentially outward from tip ends of teeth 3b; and concentrated winding coils 4a that are wound into a concentrated winding on each of the teeth 3b; and a rotor 5 in which permanent magnets 9 are embedded into a rotor core 6. In other words, the embedded permanent magnet electric motor 22 according to Comparative Example 3 is a combination of a circular arc-shaped rotor core and semi-closed slots.

From FIG. 2, it has been confirmed that the present invention, which is a combination of a circular arc-shaped rotor core and open slots, can reduce eddy current loss in the permanent magnets 9 and 9A compared to Comparative Examples 1 through 3. It has also been confirmed that eddy current loss in the permanent magnets 9 and 9A can be reduced if a circular arc-shaped rotor core is used (the present invention and Comparative Example 3) compared to when a cylindrical rotor core is used (Comparative Examples 1 and 2).

Next, the results of the analyses in FIG. 2 will be investigated.

From the results of the analyses of Comparative Examples 1 and 2, eddy current loss in the permanent magnets 9A was reduced by changing from open slots to semi-closed slots in the case of a cylindrical rotor core. From this it can be inferred that whereas in the case of open slots the magnetic flux density changes suddenly at the edge portions (the circumferential end portions) of the teeth 3b, and large eddy currents arise in the permanent magnets 9A because the flange portions 3d on the tip ends of the teeth 3b are omitted, in the case of the semi-closed slots, the flange portions 3d on the tip ends of the teeth 3b give rise to magnetic saturation, making the change in magnetic flux density more gradual, and reducing the eddy currents that arise in the permanent magnets 9A.

From the results of the analyses of the present invention and Comparative Example 1, in the case of open slots, eddy current loss in the permanent magnets 9 and 9A was reduced by changing from a cylindrical rotor core to a circular arc-shaped rotor core. As shown in FIG. 7, by changing from a cylindrical rotor core to a circular arc-shaped rotor core, the air gap between the teeth 3b and the rotor core 6 increases circumferentially away from the magnetic pole centers. Thus, it can be inferred that sudden changes in the magnetic flux density at the side edges of the teeth 3b of the open slots are alleviated, reducing eddy currents that arise in the permanent magnets 9 and 9A.

From the results of the analyses of the present invention and Comparative Example 3, in the case of a circular arc-shaped rotor core, eddy current loss in the permanent magnets 9 was reduced by changing from semi-closed slots to open slots.

Here, as shown in FIGS. 6 and 7, the magnetic flux A enters the rotor core 6 from the teeth 3b, crosses the permanent magnets 9, and enters neighboring teeth 3b. Moreover, in FIGS. 6 and 7, B is a cylindrical surface.

As shown in FIG. 6, in the case of semi-closed slots, the flange portions 3d are in close proximity to each other. Thus, when a gap between the flange portions 3d is positioned in a vicinity of a magnetic pole center, the air gap is reduced, increasing magnetic flux A. Then, as the gap between the flange portions 3d moves away from the magnetic pole center, the air gap increases, reducing the magnetic flux A. Thus, in the case of the semi-closed slots, the benefit of air gap expansion due to the circular arc-shaped rotor core is received only when the gap between the flange portions 3d is away from the magnetic pole center.

In the case of open slots, on the other hand, when one of the teeth 3b is positioned in the vicinity of a magnetic pole center, and the air gap is reduced, as shown in FIG. 7, another tooth 3b is separated from the magnetic pole center, increasing the air gap. Thus, it can be inferred that the magnetic flux A is reduced irrespective of the position of the rotor core 6, reducing the amount of magnetic flux that crosses the permanent magnets 9, and thereby reducing eddy currents that arise in the permanent magnets 9.

Thus, according to Embodiment 1, because slots 3c of a stator core 3 of an embedded permanent magnet electric motor 1 are configured into open slots, mounting of concentrated winding coils 4a is facilitated, and inductance of a stator coil 4 is also reduced, enabling increased output during high-speed rotation.

Because the slots 3c of the stator core 3 are configured into open slots, and a rotor core 6 is configured into a circular arc-shaped rotor core, the occurrence of eddy currents in permanent magnets 9 is suppressed. As a result, eddy current loss in the permanent magnets 9 is reduced, suppressing temperature increases in the permanent magnets 9, and enabling decreases in the magnetic flux of the permanent magnets 9, and thermal demagnetization, etc., to be prevented.

In a cross section that is perpendicular to a central axis O₀ of a shaft 10, circular arc-shaped curved surfaces 7 are formed into circular arcs of radius r₁ around O₁, and outer circumferential inner wall surfaces of magnet insertion apertures 8 are formed into circular arcs of radius r₂ around O₁. In other words, circular arc centers of the outer circumferential inner wall surfaces of the magnet insertion apertures 8 coincide with circular arc centers of the circular arc-shaped curved surfaces 7. Thus, the thickness of the rotor core 6 between the circular arc-shaped curved surfaces 7 and the magnet insertion apertures 8 is uniform, enabling concentrations of stress at the portions in question to be alleviated, and increasing resistance to centrifugal forces of the rotor 5.

In the cross section that is perpendicular to the central axis O₀ of the shaft 10, the outer circumferential inner wall surfaces of the magnet insertion apertures 8 are formed into circular arcs of radius r₂ around O₁. In other words, outer circumferential outer wall surfaces of the permanent magnets 9 are formed into circular arc shapes that are convex radially outward. Thus, distances between the permanent magnets 9 that are embedded inside the rotor core 6 and the circular arc-shaped curved surfaces 7 can be shortened, increasing eddy current-reducing effects.

In the cross section that is perpendicular to the central axis O₀ of the shaft 10, the outer circumferential inner wall surfaces of the magnet insertion apertures 8 and the inner circumferential inner wall surfaces are respectively formed into circular arcs of radius r₂ and radius r₃ around O₁. Thus, because the permanent magnets 9 are formed into rectangular shapes that have circular arc-shaped cross sections that are identical to the internal shapes of the magnet insertion apertures 8, the amount of permanent magnet material used can be reduced.

### Embodiment 2

FIG. 8 is an end elevation that schematically shows a stator core that is used in an embedded permanent magnet electric motor according to Embodiment 2 of the present invention.

In FIG. 8, a stator core 3B is formed by laminating and integrating a large number of electromagnetic steel plates that have been punched into identical shapes, for example, and has: an annular core back 3a; and six teeth 11 that are formed so as to have tapered shapes in which respective circumferential widths become gradually narrower radially inward, that are disposed so as to extend radially inward from an inner circumferential surface of the core back 3a, and that are arranged at a uniform angular pitch circumferentially.

Moreover, the rest of the configuration is formed in a similar manner to Embodiment 1 above.

According to Embodiment 2, because each of the teeth 11 are formed so as to have a tapered shape in which a circumferential width become gradually narrower radially inward, concentrated winding coils 4a that are formed by winding conductor wires can be mounted smoothly onto the teeth 11. Assembly of the stator can thereby be improved, and the occurrence of damage to insulating coatings of the concentrated winding coils 4a can also be suppressed when the concentrated winding coils 4a are mounted onto the teeth 11.

### Embodiment 3

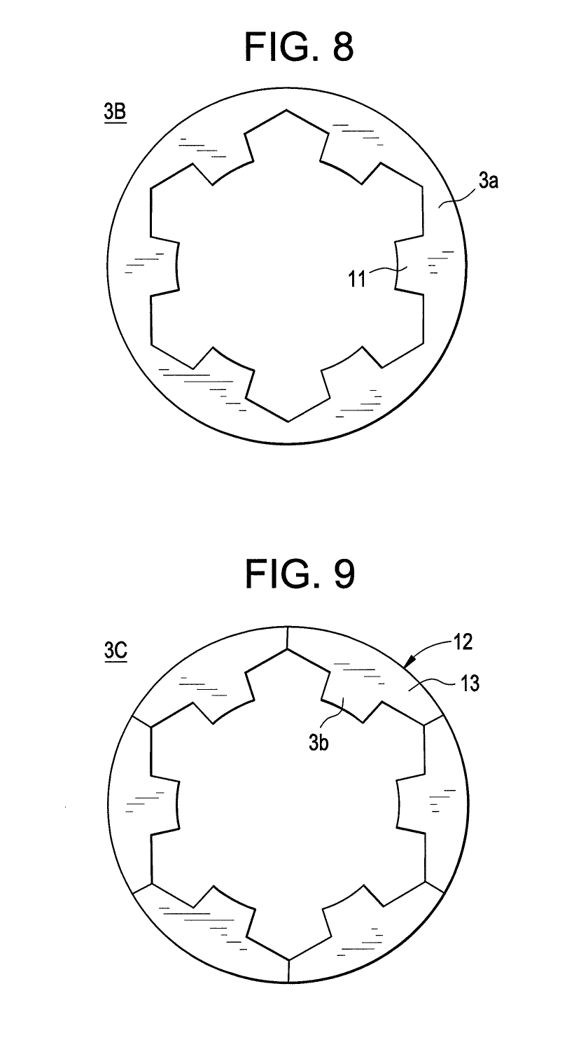

FIG. 9 is an end elevation that schematically shows a stator core that is used in an embedded permanent magnet electric motor according to Embodiment 3 of the present invention.

In FIG. 9, core segments 12 are formed by laminating and integrating a large number of electromagnetic steel plates that have been punched into identical shapes, and have: a core back portion 13; and a tooth 3b that is disposed so as to extend radially inward from a circumferential center of an inner circumferential surface of the core back portion 13. A stator core 3C is configured by press-fitting six core segments 12 into an annular frame (not shown) so as to be arranged in an annular shape circumferentially. The core back portions 13 are linked circumferentially to configure a core back 3a.

Moreover, the rest of the configuration is formed in a similar manner to Embodiment 1 above.

According to Embodiment 3, because the stator core 3C is configured so as to be divided into six core segments 12, concentrated winding coils 4a can easily be wound onto the tooth 3b of the core segments 12 at a high density. Thus, coil space factor can be improved.

### Embodiment 4

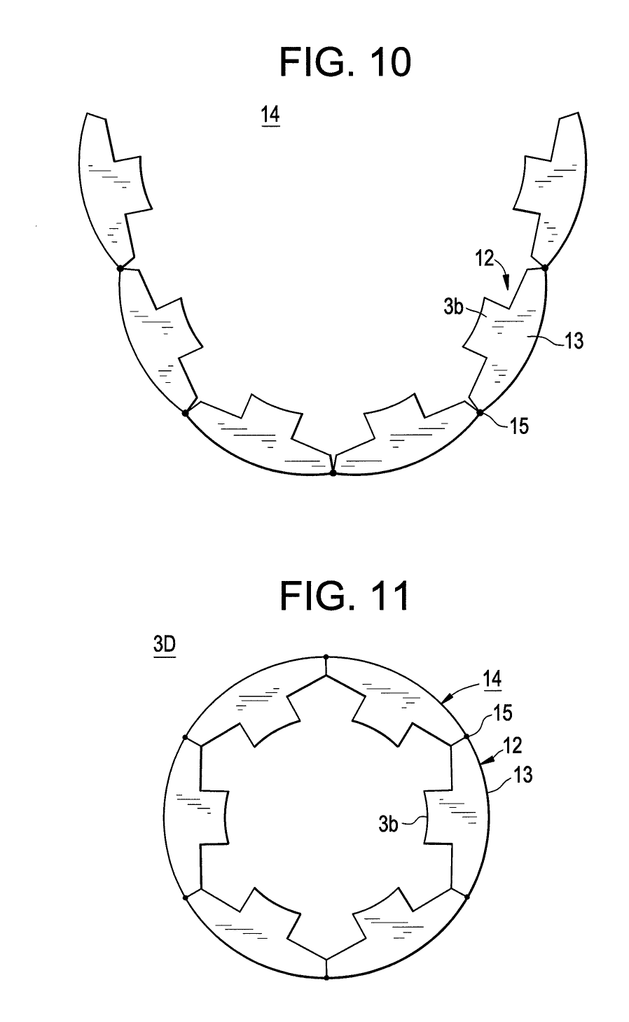

FIG. 10 is an end elevation that schematically shows a core segment group that constitutes a stator core that is used in an embedded permanent magnet electric motor according to Embodiment 4 of the present invention, and FIG. 11 is an end elevation that schematically shows the stator core that is used in the embedded permanent magnet electric motor according to Embodiment 4 of the present invention.

In FIGS. 10 and 11, a core segment group 14 is configured such that outer circumferential portions of circumferential end surfaces of core back portions 13 of six core segments 12 are linked to each other by bendable linking portions 15. A stator core 3D is configured by rolling up the core segment group 14 into an annular shape by bending each of the linking portions 15, and press-fitting the core segment group 14 into an annular frame (not shown).

Moreover, the rest of the configuration is formed in a similar manner to Embodiment 1 above.

In Embodiment 4, thin portions that link the outer circumferential portions at two circumferential ends of the core back portions 13 of the core segments 12 are formed simultaneously when electromagnetic steel plates are shaped by punching. Then a large number of the punched electromagnetic steel plates are laminated and integrated to form a core segment group 14 in which six core segments 12 are linked by laminated portions of the thin portions, in other words, by bendable linking portions 15.

According to Embodiment 4, because a core segment group 14 is configured such that six core segments 12 are linked to each other by bendable linking portions 15, concentrated winding coils 4a can easily be wound onto the teeth 3b of the core segments 12 at a high density in a state in which the core segment group 14 is laid out flat before being bent into an annular shape and press-fitted into an annular frame. Thus, coil space factor can be improved.

Moreover, in Embodiment 4 above, the linking portions are constituted by thin portions, but the linking portions need only be configured so as to enable bending, and recess portions may also be formed on first facing end portions of adjacent core segments, and salient portions formed on second outer circumferential portions such that the recess portions and the salient portions are fitted together pivotably, for example.

In Embodiment 4 above, a core segment group is bent at linking portions, rolled up into an annular shape, and press-fitted into an annular frame, but the core segment group may also be bent at linking portions and rolled up into an annular shape, and then end surfaces of the two end core back portions abutted to each other and joined by welding.

### Embodiment 5

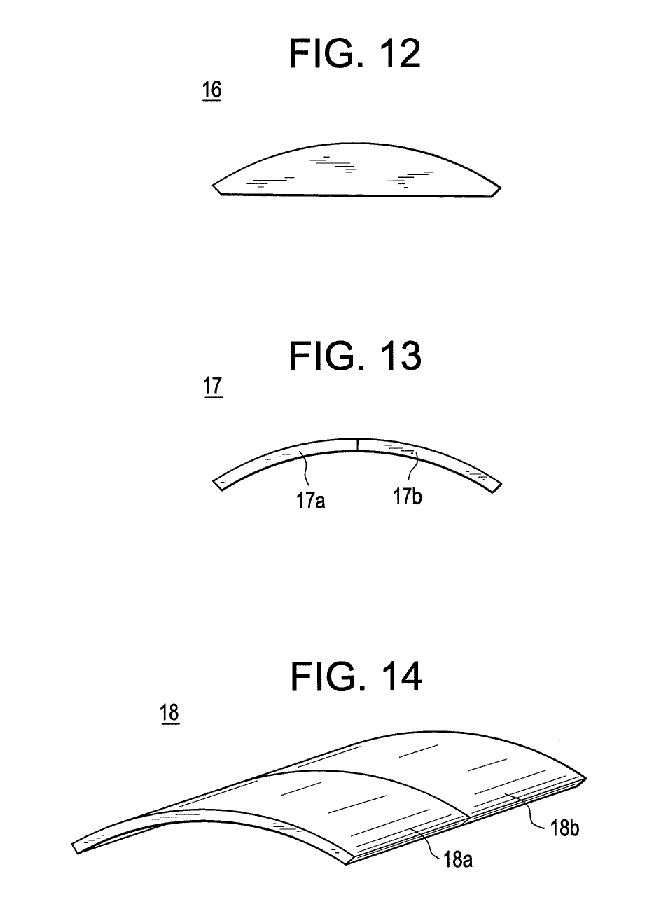

FIG. 12 is an end elevation that shows a permanent magnet that is used in an embedded permanent magnet electric motor according to Embodiment 5 of the present invention.

In FIG. 12, permanent magnets 16 are formed into rectangular shapes that have a D-shaped cross section that has an outer circumferential outer wall surface that is a circular arc-shaped curved surface and an inner circumferential outer wall surface that is a flat surface.

Moreover, the rest of the configuration is formed in a similar manner to Embodiment 1 above.

According to Embodiment 5, it is not necessary to shape the inner circumferential outer wall surfaces of the permanent magnets 16 into circular arc-shaped curved surfaces, enabling costs to be reduced.

### Embodiment 6

FIG. 13 is an end elevation that shows a permanent magnet that is used in an embedded permanent magnet electric motor according to Embodiment 6 of the present invention.

In FIG. 13, a permanent magnet 17 is divided into two sections circumferentially to form a first permanent magnet 17a and second permanent magnet 17b. Although not shown, the first permanent magnet 17a and the second permanent magnet 17b are inserted into a magnet insertion aperture that passes axially through a rotor core so as to line up circumferentially so as to have a minute gap interposed.

Moreover, the rest of the configuration is formed in a similar manner to Embodiment 1 above.

According to Embodiment 6, because the permanent magnets 17 are divided into two sections circumferentially, the width of the permanent magnets to which the magnetic flux interlinks is halved, suppressing the occurrence of eddy currents, thereby enabling eddy current loss to be reduced.

### Embodiment 7

FIG. 14 is a perspective that shows a permanent magnet that is used in an embedded permanent magnet electric motor according to Embodiment 7 of the present invention.

In FIG. 14, a permanent magnet 18 is divided into two sections axially to form a first permanent magnet 18a and second permanent magnet 18b. Although not shown, the first permanent magnet 18a and the second permanent magnet 18b are inserted into a magnet insertion aperture that passes axially through a rotor core so as to line up axially so as to have a minute gap interposed.

Moreover, the rest of the configuration is formed in a similar manner to Embodiment 1 above.

In Embodiment 7, because the permanent magnets 18 are divided into two sections axially, eddy current stream lines are also divided, enabling eddy currents to be reduced, thereby enabling eddy current loss to be reduced.

Moreover, in Embodiments 6 and 7 above, first permanent magnets and second permanent magnets are disposed so as to have minute gaps interposed, but the first permanent magnets and the second permanent magnets need only be electrically insulated, and an electrically insulating resin, for example, may also be interposed.

In Embodiments 6 and 7 above, the permanent magnets are divided into two sections, but the number of permanent magnet sections is not limited to two.

In each of the above embodiments, a ratio between a magnetic pole count and a slot count in the embedded permanent magnet electric motors is 4:6, i.e., a pole-to-slot ratio is 2:3, but the pole-to-slot ratio is not limited to 2:3, and may also be 4:3, for example.

What is claimed is:

1. An embedded permanent magnet electric motor comprising:
a rotor comprising:
a rotor core that has an outer circumferential surface that is formed into a plurality of continuous convex surfaces by arranging circular arc-shaped curved surfaces at a uniform angular pitch circumferentially, and
a plurality of permanent magnets that are embedded in said rotor core so as to be positioned on a radially inner side of each of said circular arc-shaped curved surfaces,
said permanent magnets that are embedded in inner radial sides of adjacent circular arc-shaped curved surfaces being magnetized so as to have polarities that are different than each other to constitute magnetic poles; and
a stator comprising:
a stator core in which teeth are respectively disposed so as to extend radially inward from an annular core back and are arranged at a uniform angular pitch circumferentially to configure open slots; and
a stator coil that is constituted by a plurality of concentrated winding coils that are wound into concentrated windings on each of said teeth,
said stator being disposed so as to surround said rotor.

2. An embedded permanent magnet electric motor according to claim 1, wherein said teeth are formed so as to have a tapered shape in which a circumferential width thereof gradually becomes slender on a radially inner side.

3. An embedded permanent magnet electric motor according to claim 1, wherein said teeth are disposed so as to extend radially inward from circumferential centers of inner circumferential surfaces of core back portions of core segments, and said stator core is configured by arranging said core segments into an annular shape.

4. An embedded permanent magnet electric motor according to claim 1, wherein said teeth are disposed so as to extend radially inward from circumferential centers of inner circumferential surfaces of core back portions of core segments, a core segment group is configured by linking together outer circumferential portions of each of said core back portions by bendable linking portions, and said stator core is configured into an annular shape by bending said core segment group at said linking portions.

5. An embedded permanent magnet electric motor according to claim 1, wherein an outer circumferential outer wall surface of said permanent magnets is formed into a circular arc shape that is radially outwardly convex in a plane that is perpendicular to a central axis of said rotor core.

6. An embedded permanent magnet electric motor according to claim 5, wherein an inner circumferential outer wall surface of said permanent magnets is formed into a circular arc shape that is radially outwardly convex in a plane that is perpendicular to a central axis of said rotor core.

7. An embedded permanent magnet electric motor according to claim 5, wherein a circular arc center of said outer circumferential outer wall surface of said permanent magnets coincides with a circular arc center of said circular arc-shaped curved surfaces in a plane that is perpendicular to a central axis of said rotor core.

8. An embedded permanent magnet electric motor according to claim 1, wherein said permanent magnets are divided into a plurality of sections circumferentially.

9. An embedded permanent magnet electric motor according to claim 1, wherein said permanent magnets are divided into a plurality of sections axially.
